(19) United States
(12) Patent Application Publication
(10) Pub. No.: US 2019/0064527 A1
(43) Pub. Date: Feb. 28, 2019

(54) HEAD MOUNTED DISPLAY APPARATUS AND IMAGING LENS

(71) Applicant: Coretronic Corporation, Hsin-Chu (TW)

(72) Inventors: Tao-Hung Kuo, Hsin-Chu (TW); Chuan-Te Cheng, Hsin-Chu (TW)

(21) Appl. No.: 16/013,841

(22) Filed: Jun. 20, 2018

(30) Foreign Application Priority Data
Aug. 31, 2017 (CN) 201710769964.6

(51) Int. Cl. G02B 27/01

(52) U.S. Cl. CPC G02B 27/0176; G02B 2027/015; G02B 27/0172

(57) ABSTRACT

A head mounted display apparatus includes a display device. The display device includes an image source and an imaging lens. The image source is adapted to provide an image beam, and adjacent to a narrowing end. The imaging lens is disposed on a transmission path of the image beam, and disposed between an amplifying end and the narrowing end. The imaging lens includes a light redirecting element, a first lens, a second lens, and a third lens arranged sequentially from the amplifying end to the narrowing end. Refractive powers of the first lens, the second lens, and the third lens are positive, negative, and positive respectively. An imaging lens adapted to be applied to the head mounted display apparatus is also provided. The head mounted display apparatus and its imaging lens has a small size and good optical characteristics.

### CROSS-REFERENCE TO RELATED APPLICATION

THIS APPLICATION CLAIMS THE PRIORITY BENEFIT OF CHINA APPLICATION (CN201710769964.6 FILED ON 2017, Aug. 31). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a display apparatus, and more particularly to a head mounted display apparatus and an imaging lens thereof.

### BACKGROUND OF THE INVENTION

In a head mounted display apparatus, an image source is used for providing an image beam and an imaging lens is used for imaging the image beam onto the retina of the human eyes. The head mounted display apparatus is a new product with great potential for production and is often used in virtual reality (VR), mixed reality (MR) and augmented reality (AR).

In a conventional head mounted display apparatus, the imaging lens and the image source are generally designed to be arranged in front of the wearer's eyes, so that the frame for accommodating the imaging lens and the image source has a thicker thickness problem.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a head mounted display apparatus having the advantage of being thinner.

The invention provides an imaging lens that can be applied to a head mounted display apparatus so that the head mounted display apparatus can have the advantage of being thinner.

Other advantages of the invention may be further understood from the technical features disclosed herein.

In order to achieve one or part or all of the above objectives or other objectives, a head mounted display apparatus provided by an embodiment of the invention includes a display device. The display device includes an image source and an imaging lens. The image source is adapted to provide an image beam, and adjacent to a narrowing end. The imaging lens is disposed on a transmission path of the image beam, and disposed between an amplifying end and the narrowing end. The imaging lens includes a light redirecting element, a first lens, a second lens, and a third lens arranged sequentially from the amplifying end to the narrowing end. Refractive powers of the first lens, the second lens, and the third lens are positive, negative, and positive respectively.

In order to achieve one or part or all of the above objectives or other objectives, an imaging lens provided by an embodiment of the invention is adapted for a head mounted display apparatus, and adapted to be disposed between an amplifying end and a narrowing end. The imaging lens includes a light redirecting element, a first lens, a second lens, and a third lens arranged sequentially from the amplifying end to the narrowing end. Refractive powers of the first lens, the second lens, and the third lens are positive, negative, and positive respectively.

In summary, in the head mounted display apparatus and the imaging lens of the embodiment of the invention, since the imaging lens has a light redirecting element, the image source and the lenses of the imaging lens are not necessary to be disposed in front of the wearer's eyes, as a result, the thickness of the part of the head mounted display apparatus located in front of the wearer's eyes may be made thinner.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a head mounted display apparatus in accordance with an embodiment of the invention;

FIG. 2 is a schematic view of a display device in accordance with an embodiment of the invention;

FIG. 3A is a lateral color plot of an embodiment of the imaging lens in FIG. 2;

FIG. 3B is a field curvature plot of an embodiment of the imaging lens in FIG. 2;

FIG. 3C is a distortion plot of an embodiment of the imaging lens in FIG. 2;

FIG. 3D is a transverse ray fan plot of an embodiment of the imaging lens in FIG. 2;

FIG. 3E is a modulation transfer function (MTF) plot of an embodiment of the imaging lens in FIG. 2;

FIG. 4 is a schematic view of a display device in accordance with another embodiment of the invention;

FIG. 5A is a lateral color plot of an embodiment of the imaging lens in FIG. 4;

FIG. 5B is a field curvature plot of an embodiment of the imaging lens in FIG. 4;

FIG. 5C is a distortion plot of an embodiment of the imaging lens in FIG. 4;

FIG. 5D is a transverse ray fan plot of an embodiment of the imaging lens in FIG. 4;

FIG. 5E is a modulation transfer function plot of an embodiment of the imaging lens in FIG. 4; and

FIG. 6 is a schematic view of a display device in accordance with another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

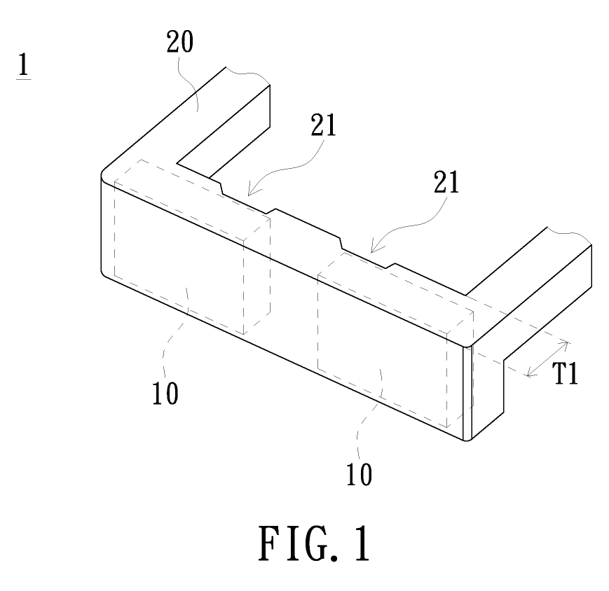

FIG. 1 is a schematic view of a head mounted display apparatus in accordance with an embodiment of the invention. Referring to FIG. 1, the head mounted display apparatus 1 of the embodiment includes at least one display device 10. FIG. 1 is exemplified by two display devices 10 for the two eyes of the user to view, but the invention does not limit the number of display devices. In addition, in the embodiment, the head mounted display apparatus 1 may further include a wearing frame 20, and the display device 10 is disposed to the wearing frame 20. In the embodiment, the user may, for example, wear the wearing frame 20 on his or her head, so that the user may view the image provided by the display device 10 from the display window 21 of the wearing frame 20; however, the invention does not limit the specific structure of the wearing frame.

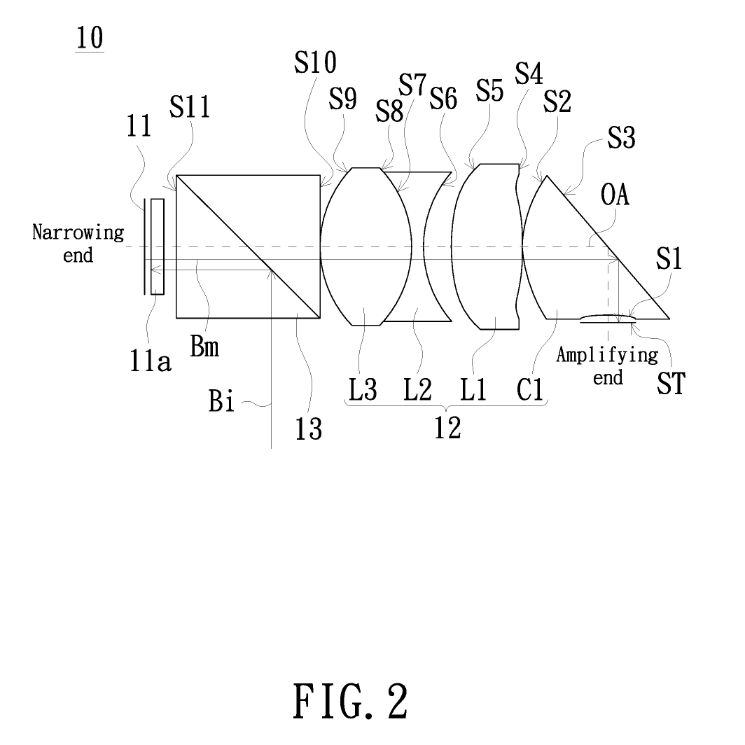

FIG. 2 is a schematic view of a display device in accordance with an embodiment of the invention. Referring to FIG. 2, the display device 10 of the embodiment includes an image source 11 and an imaging lens 12. The image source 11 is adapted to provide an image beam Bm and is adjacent to the narrowing end. In the embodiment, the imaging lens 12 is disposed/located on the transmission path of the image beam Bm and is disposed/located between the amplifying end and the narrowing end. Specifically, in the embodiment, the display device 10 further includes, for example, a light source (not shown) adapted to provide an illumination beam Bi. In the embodiment, the image source 11 is a light valve for example. The mage source 11 is adapted to convert the illumination beam Bi into the image beam Bm, and the imaging lens 12 is adapted to project the image beam Bm from the image source 11. In the embodiment, the image beam Bm is projected, for example, by the imaging lens 12 to the display window 21 in FIG. 1, and the human eyes may receive the image transmitted by the image beam Bm by the display window 21. In other embodiments, the display device 10 may not include a light source, and the illumination beam Bi is provided by an external light source or ambient light.

The above image source 11 is, for example, a reflective light valve such as a digital micro-mirror device (DMD), a liquid crystal display (LCD) panel or a liquid crystal on silicon (LCoS) panel. In the embodiment, the display device 10 further includes, for example, a prism 13. The prism 13 is disposed between the image source 11 and the imaging lens 12. In the embodiment, the prism 13 is, for example, a total internal reflection (TIR) prism. The prism 13 may reflect the illumination beam Bi to the image source 11, and the image beam Bm provided by the image source 11 passes through the prism 13 to the imaging lens 12. It is to be noted that the invention does not limit the specific structure of the display device. In other embodiments, the prism 13 may be omitted by changing the relative positions of the light source and the image source 11. Alternatively, in some embodiments, the prism 13 may be omitted by employing a transmissive light valve as an image source.

In the embodiment, the imaging lens 12 includes a light redirecting element C1, a first lens L1, a second lens L2, and a third lens L3 arranged sequentially from the amplifying end to the narrowing end. The refractive powers of the first lens L1, the second lens L2, and the third lens L3 are positive, negative, and positive respectively. In the embodiment, the light redirecting element C1 may have a refractive power, for example, having a negative refractive power. In the embodiment, the third lens L3 is adjacent to the image source 11.

Specifically, in the embodiment, the light redirecting element C1 has a light exit surface S1, a light entrance surface S2 and a reflective surface S3. In the embodiment, the light entrance surface S2 is connected between the light exit surface S1 and the reflective surface S3, the light exit surface S1 is connected between the light entrance surface S2 and the reflective surface S3, and the reflective surface S3 is connected between the light entrance surface S2 and the light exit surface S1. In the embodiment, the light entrance surface S2 has a convex curved surface facing the first lens L1, the reflective surface S3 is a flat surface or a curved surface (FIG. 2 is exemplified by a flat surface, but the invention is not limited thereto), the light exit surface S1 is a concave curved surface, but the invention is not limited thereto. In addition, the invention does not limit that the light redirecting element has a negative refractive power. In other embodiments, the light redirecting element C1 may have no refractive power. In addition, in the embodiment, the reflective surface S3 is, for example, a total reflection surface, and the reflective surface S3 may reflect the image beam Bm to the light exit surface S1. In one embodiment, the reflective surface S2 turns the image beam Bm by 90 degrees for example, that is, in FIG. 2, the reflective surface S2 turns the image beam Bm traveling from left to right to the image beam Bm traveling from up to down for example. In one embodiment, the reflective surface S3 of the light redirecting element C1 may be a mirror to reflect the image beam Bm to the human eyes, thereby enabling the display device 10 to be applied to the virtual reality, but the invention is not limited thereto. In the embodiment, the light redirecting element C1 is, for example, a light redirecting prism and has a negative refractive power.

In some embodiments, the light redirecting element C1 may be a semi-transmissive-and-semi-reflective element. Specifically, in other embodiments, the reflective surface S3 of the light redirecting element C1 may be a surface disposed with a reflective coating. The reflective coating may be, for example, a semi-transmissive-and-semi-reflective coating. The semi-transmissive-and-semi-reflective coating (the reflective surface S3) allows the external ambient light to pass therethrough or reflect the image beam Bm, so that both of the external ambient light and the image beam Bm may enter the human eyes, thereby enabling the display device 10 to be applied to the augmented reality, but the invention is not limited thereto. For example, in some embodiments, the display device 10 may also be applied to a mixed reality. In other embodiments, a mirror or a plate with a reflective coating may be employed as the light redirecting element C1, wherein the reflective coating may also be a semi-transmissive-and-semi-reflective coating.

The first lens L1, the second lens L2, and the third lens L3 of the embodiment are aspherical lenses for example, but the invention is not limited thereto. In other embodiments, any of the first lens L1, the second lens L2, and the third lens L3 may be a spherical lens. In addition, in the embodiment, the first lens L1 and the third lens L3 are bi-convex lenses for example, and the second lens L2 is a bi-concave lens for example. In addition, the material of the first lens L1, the second lens L2, and the third lens L3 of the embodiment is, for example, a plastic material, but may be a glass material in other embodiments.

In addition, in the embodiment, the imaging lens 12 has an aperture stop surface ST for example, and the aperture stop surface ST is opposite to the light exit surface S1. In the embodiment, the aperture stop surface ST is a place where an aperture stop is disposed, rather than a physical surface. In the embodiment, the display window 21 in FIG. 1 is disposed, for example, in the aperture stop surface ST as an aperture stop. In the embodiment, the display window 21 may be a hollow window frame so that the user's eyes may be disposed/located on the aperture stop surface ST, but the invention is not limited thereto. In another embodiment, a light transmissive sheet may be disposed in the window frame of the display window 21, but the invention is not limited thereto.

In the embodiment, since the imaging lens 12 has the light redirecting element C1, the image beam Bm traveling from left to right may be turned into the image beam Bm traveling from up to down, and the image source 11 and the first lens L1, the second lens L2 and the third lens L3 of the imaging lens 12 are not necessary to be disposed in front of the wearer's eyes. As a result, the thickness T1 of the part of the head mounted display apparatus 1 of FIG. 1 disposed/located in front of the wearer's eyes may be made thinner, thereby helping to reduce the size and weight of the head mounted display apparatus 1 and enhance the comfort of the wearer.

In one embodiment, in order to further reduce the thickness T1 of the head mounted display apparatus 1, the imaging lens 12 may satisfy the relationship: D<5 mm, wherein D is the distance between the aperture stop surface ST and the light exit surface S1 (calculated based on the central axis).

In one embodiment, in order to provide a sufficient space between the third lens L3 and the image source 11 to dispose the prism 13, the imaging lens 12 may satisfy the relationship: BEF/f>0.5, wherein BEF is the back focal length of the imaging lens 12 and is referred to the air equivalent back focal length, and f is the effective focal length of the imaging lens 12. However, in addition to providing sufficient space to avoid interference between the prism 13 and the third lens L3, the above condition may also help to enhance the field of view (FOV) of the imaging lens 12.

In one embodiment, in order to further reduce the length of the imaging lens 12 to reduce the overall size, the imaging lens 12 may satisfy the relationship: 1<TTL/f<5, wherein TTL is the total length of the imaging lens 12, that is, the distance from the light exit surface S1 of the first lens L1 to the reflective surface S3 added to the distance from the reflective surface S3 to the surface S9 (the surface facing the narrowing end) of the third lens L3 (calculated based on the central axis).

An embodiment of the parameters of the imaging lens 12 will be described in Table 1. However, the data listed in Table 1 is not intended to limit the invention, and any person skilled in the art will be able to make appropriate changes to these parameters or settings after reference to the invention, but the changes are still within the scope of the invention.

TABLE 1

| | | Radius of | | | |
|---|---|---|---|---|---|
| | | curvature | Spacing | Refractive | Abbe |
| Element | Surface | (mm) | (mm) | index | number |
| Aperture stop | ST | Infinite | 0.4 | | |
| surface | | | | | |
| Light | S1 | −9.01 | 11.89 | 1.79 | 45.3 |
| redirecting | S2 | −10.28 | 0.1 | | |
| element | | | | | |
| First lens | S4 | 16.44 | 5.91 | 1.53 | 56.04 |
| | S5 | −17.56 | 2.43 | | |
| Second lens | S6 | −6.5 | 0.75 | 1.58 | 29.91 |
| | S7 | 6.35 | 0.1 | | |
| Third lens | S8 | 6.11 | 7.48 | 1.53 | 56.04 |
| | S9 | −7.33 | 0.1 | | |
| Prism | S10 | Infinite | 12 | 1.74 | 44.9 |
| | S11 | Infinite | 1 | | |

The spacing in Table 1 is referred to the straight line distance between two adjacent surfaces on the optical axis OA of the imaging lens 12. For example, the spacing of the surface S5 is the straight line distance between the surface S5 and the surface S6 on the optical axis OA, the spacing of the surface S9 is the straight line distance between the surface S9 and the surface S10 of the prism 13 on the optical axis OA, and the spacing of the light exit surface S1 of the light redirecting element C1 is the sum of the distance from the light exit surface S1 to the reflective surface S3 and the distance from the reflective surface S3 to the light entrance surface S2. The spacing of the surface S11 is the distance from the surface S11 to the cover glass 11a of the image source 11.

In the embodiment, the first lens L1, the second lens L2 and the third lens L3 are aspherical lenses for example, wherein the surfaces S4, S5, S6, S7, S8 and S9 are aspherical surfaces and may be expressed by the following equation:

$$Z = \frac{{Y}^{2} / R}{1 + \sqrt{1 - ( 1 + K ) {( Y / R )}^{2}}} + {BY}^{2} + {CY}^{4} + {DY}^{6} + {EY}^{8} + {FY}^{10} + {GY}^{12} + {HY}^{14}$$

In the equation, Z is the coordinate value in the direction of the optical axis; B, C, D, E, F, G and H are the aspherical coefficients; K is the quadratic surface constant; R is the radius of curvature; Y is the coordinate value orthogonal to the direction of the optical axis, and the upward direction is the positive direction. The parameters of the surfaces S4, S5, S6, S7, S8 and S9 are shown in Table 2.

TABLE 2

| | K | B | C | D | E | F | G | H |
|---|---|---|---|---|---|---|---|---|
| S4 | 0 | 0 | −2.15E−4 | −4.45E−6 | −3.83E−8 | −3.52E−9 | 9.99E−11 | −2.57E−12 |
| S5 | 0 | 0 | −9.57E−5 | −9.05E−6 | 3.14E−7 | −1.91E−8 | 4.46E−10 | −3.62E−12 |
| S6 | 0 | 0 | 1.01E−3 | 8.99E−6 | −4.86E−7 | 5.32E−9 | 2E−10 | 0 |
| S7 | −3.41 | 0 | 4.98E−4 | −3.51E−6 | −4.75E−7 | 1.62E−8 | −1.67E−10 | 0 |
| S8 | −9.66E−1 | 0 | −8.1E−4 | 2.09E−5 | −7.15E−7 | 1.61E−8 | −1.57E−10 | 0 |
| S9 | −4.2 | 0 | −6.86E−4 | 2.25E−5 | −6.49E−7 | 1.23E−8 | −1.06E−10 | 0 |

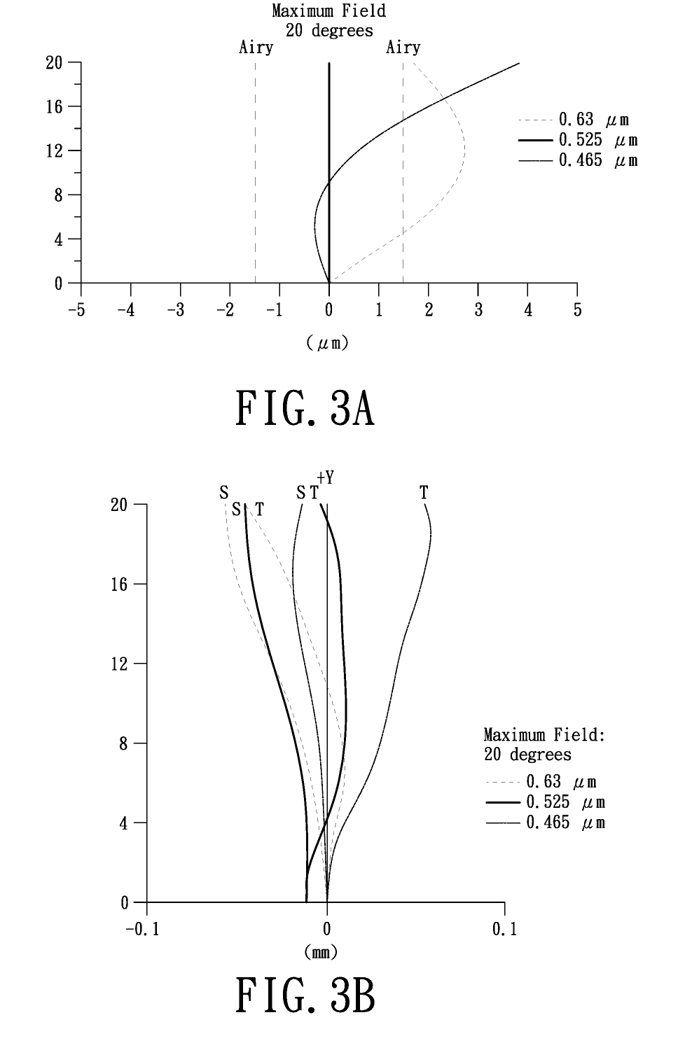

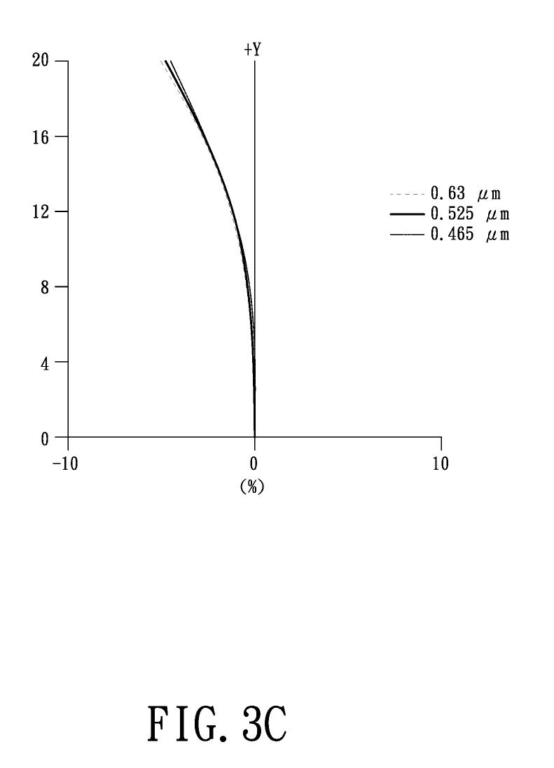

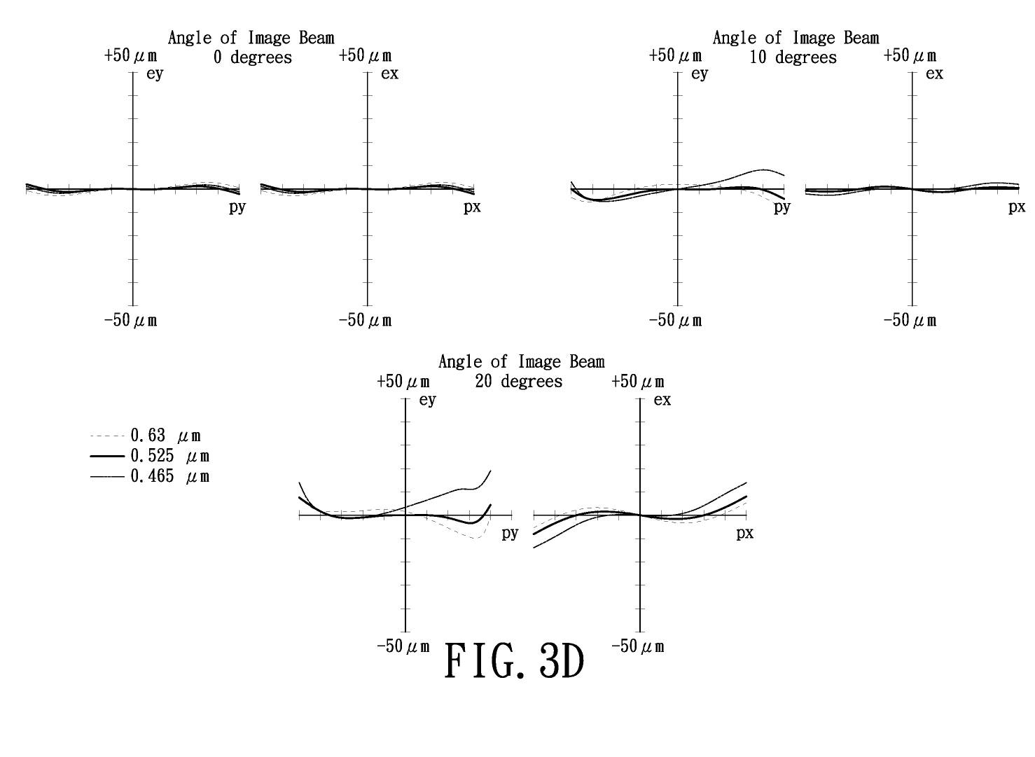

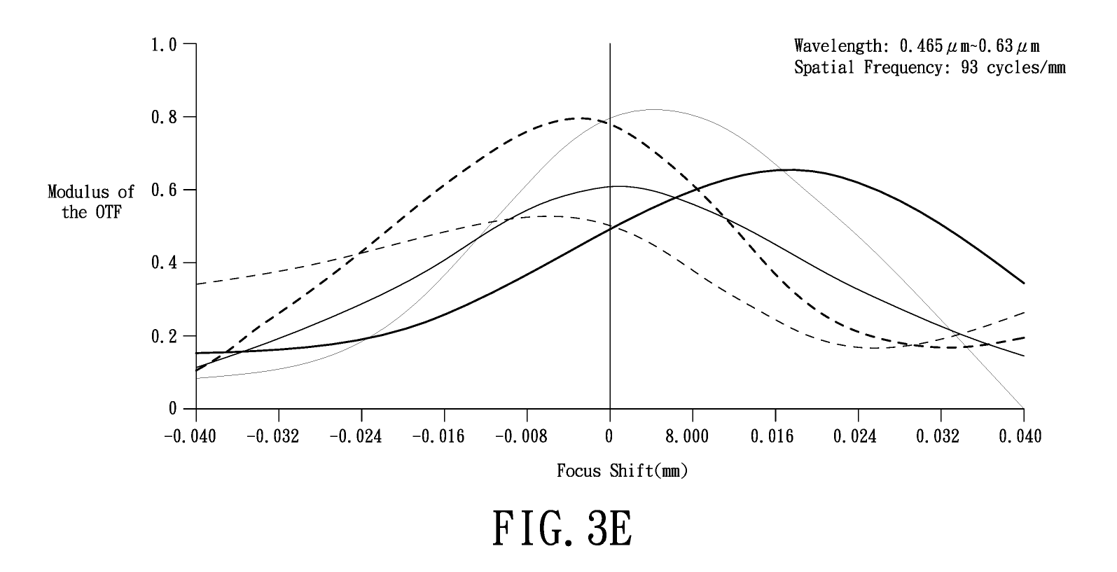

FIG. 3A is a lateral color plot of an embodiment of the imaging lens in FIG. 2. FIG. 3B is a field curvature plot of an embodiment of the imaging lens in FIG. 2. FIG. 3C is a distortion plot of an embodiment of the imaging lens in FIG. 2. FIG. 3D is a transverse ray fan plot of an embodiment of the imaging lens in FIG. 2. FIG. 3E is a modulation transfer function (MTF) plot of an embodiment of the imaging lens in FIG. 2. As shown in FIGS. 3A to 3E, the imaging lens 12 of the embodiment may have a good imaging quality under a condition of a small thickness.

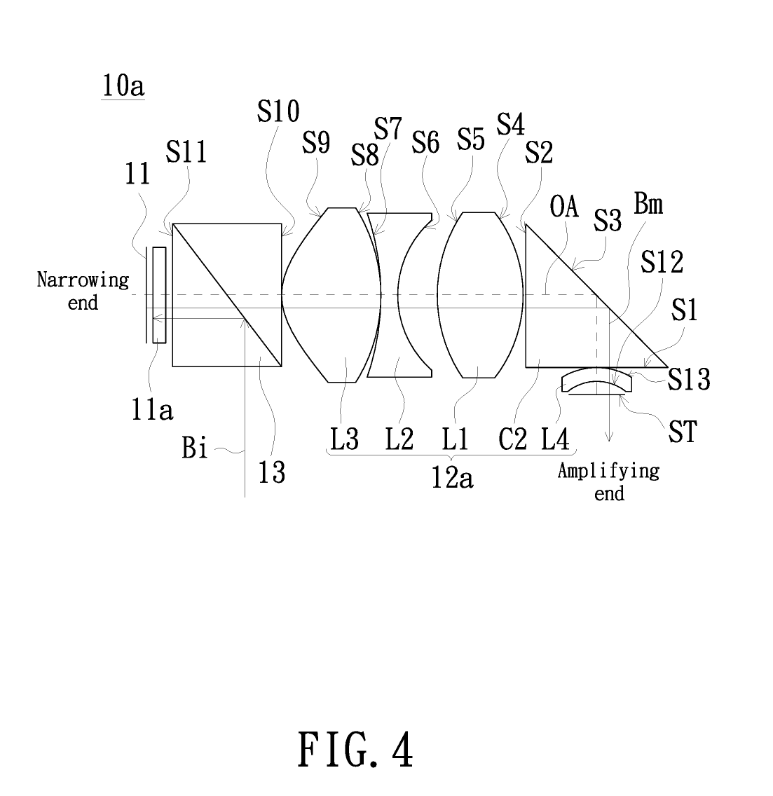

FIG. 4 is a schematic view of a display device in accordance with another embodiment of the invention. Referring to FIG. 4, similar to the display device 10 of FIG. 2, the display device 10a of the embodiment may be also applied to the head mounted display apparatus 1 of FIG. 1. The main difference between the display devices 10a and 10 is the imaging lens. The imaging lens 12a of the display device 10a of the embodiment further includes a fourth lens L4, as compared with the imaging lens 12 in FIG. 2. In the embodiment, the fourth lens L4 has a negative refractive power (i.e., a focal length is less than 0) and is disposed/located between the aperture stop surface ST of the imaging lens 12a and the light redirecting element C2. In the embodiment, the light redirecting element C2 is disposed between the first lens L1 and the fourth lens L4. In the embodiment, the fourth lens L4 is, for example, a convex-concave lens having its convex surface facing the light exit surface S1 of the light redirecting element C2 and is an aspherical lens, but the invention is not limited thereto. In other embodiments, the fourth lens L4 may be a spherical lens. In addition, the material of the fourth lens L4 of the embodiment is, for example, a plastic material, but may be a glass material in other embodiments.

In the embodiment, the light redirecting element C2 is a light redirecting prism for example, and the light redirecting element C2 is a light redirecting prism having no refractive power for example. Specifically, in the embodiment, the light exit surface S1, the light entrance surface S2 and the reflective surface S3 of the light redirecting element C2 are, for example, flat surfaces. Compared with the imaging lens 12 in FIG. 2, the imaging lens 12a of the embodiment should further include a fourth lens L4 having a negative refractive power so that the light redirecting element C2 may have no refractive power.

An embodiment of the parameters of the imaging lens 12a will be described in Table 3. However, the data listed in Table 3 is not intended to limit the invention, and any person skilled in the art will be able to make appropriate changes to these parameters or settings after reference to the invention, but the changes are still within the scope of the invention.

TABLE 3

| | | Radius of | | | |
|---|---|---|---|---|---|
| | | curvature | Spacing | Refractive | Abbe |
| Element | Surface | (mm) | (mm) | index | number |
| Aperture stop | ST | Infinite | 1.02 | | |
| surface | | | | | |
| Fourth lens | S12 | −3.69 | 1.1 | 1.53 | 55.95 |
| | S13 | −5.83 | 0.1 | | |
| Light | S1 | Infinite | 12.6 | 1.85 | 23.78 |
| redirecting | S2 | Infinite | 0.1 | | |
| element | | | | | |
| First lens | S4 | 8.94 | 7.53 | 1.53 | 55.95 |
| | S5 | −8.68 | 3.35 | | |
| Second lens | S6 | −7.27 | 1.5 | 1.59 | 29.91 |
| | S7 | 9.91 | 0.15 | | |
| Third lens | S8 | 14.88 | 8.44 | 1.53 | 55.95 |
| | S9 | −5.1 | 0.1 | | |
| Prism | S10 | Infinite | 9.5 | 1.85 | 23.78 |
| | S11 | Infinite | 0.5 | | |

In the embodiment, the first lens L1, the second lens L2, the third lens L3 and the fourth lens L4 are aspherical lenses for example, wherein the surfaces S12, S13, S4, S5, S6, S7, S8 and S9 are aspherical surfaces, and the parameters of each of the aspherical surfaces are shown in Table 4.

TABLE 4

| | K | B | C | D | E | F | G | H |
|---|---|---|---|---|---|---|---|---|
| S12 | 0 | 0 | 4.78E−3 | −5.3E−5 | 3.81E−5 | −7.48E−6 | 7.85E−7 | −2.4E−8 |
| S13 | 0 | 0 | 2.07E−3 | −9.84E−6 | −9.96E−6 | 1.79E−6 | −1.63E−7 | 6.65E−9 |
| S4 | 0 | 0 | −3.17E−4 | −1.6E−6 | 1.57E−7 | −8.54E−9 | 1.54E−10 | −9.4E−13 |
| S5 | 0 | 0 | 8.23E−4 | −1.58E−5 | 6.35E−7 | −1.95E−8 | 3.08E−10 | −1.7E−12 |
| S6 | 0 | 0 | −5E−4 | 4.26E−5 | −7.41E−7 | 7.02E−9 | 2.68E−11 | 0 |
| S7 | −1.37E+1 | 0 | −5.12E−4 | 2.91E−5 | −7.77E−7 | 1.05E−8 | −5.72E−11 | 0 |
| S8 | 2.18 | 0 | −2.66E−4 | 1.48E−5 | −6.19E−7 | 1.06E−8 | −7.36E−11 | 0 |
| S9 | −2.66 | 0 | −6.46E−4 | 2.34E−5 | −4.67E−7 | 5.69E−9 | −3.11E−11 | 0 |

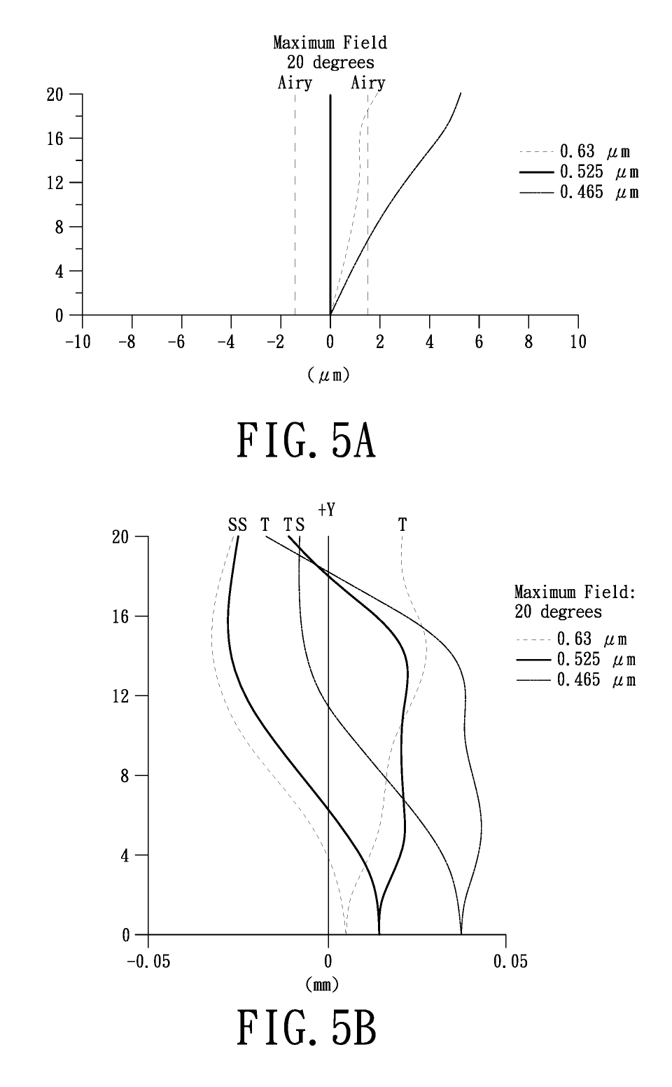

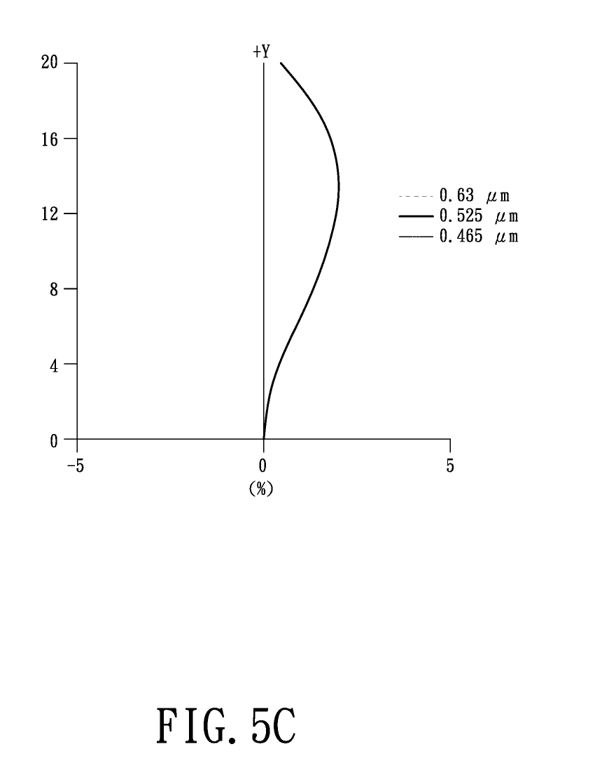

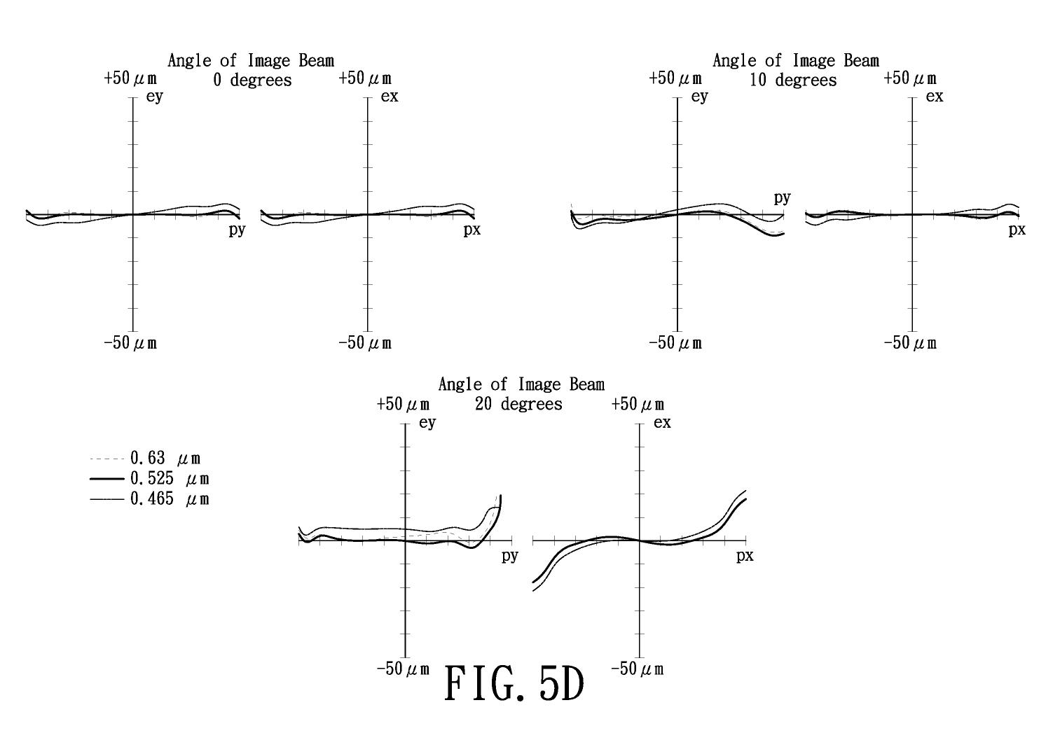

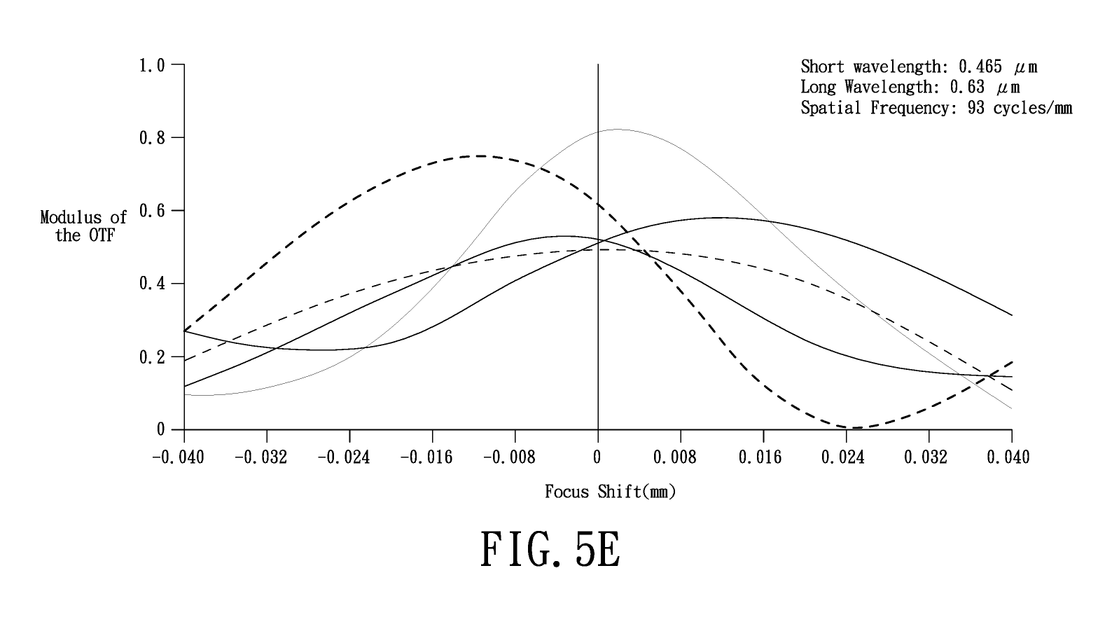

FIG. 5A is a lateral color plot of an embodiment of the imaging lens in FIG. 4. FIG. 5B is a field curvature plot of an embodiment of the imaging lens in FIG. 4. FIG. 5C is a distortion plot of an embodiment of the imaging lens in FIG. 4. FIG. 5D is a transverse ray fan plot of an embodiment of the imaging lens in FIG. 4. FIG. 5E is a modulation transfer function plot of an embodiment of the imaging lens in FIG. 4. As shown in FIGS. 5A to 5E, the imaging lens 12a of the embodiment may have a good imaging quality under a condition of a small thickness.

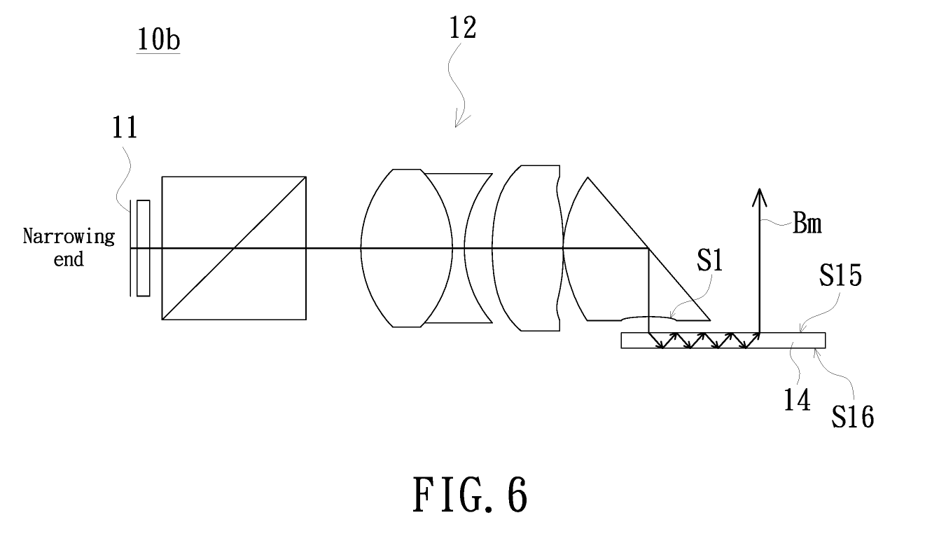

FIG. 6 is a schematic view of a display device in accordance with another embodiment of the invention. Referring to FIG. 6, the display device 10b of the embodiment is similar to the display device 10 of FIG. 2, and the main difference is that the display device 10b of the embodiment further includes a waveguide element 14, in addition to the image source 11 and the imaging lens 12. In the embodiment, the waveguide element 14 is disposed on the transmission path of the image beam Bm projected from the imaging lens 12.

Specifically, in the embodiment, the waveguide element 14 is, for example, disposed/located on the aperture stop surface of the imaging lens 12 or, for example, disposed/located on the side of the aperture stop surface of the imaging lens 12 facing the amplifying end (i.e., disposed/located on the side away from the narrowing end). In the embodiment, the image beam Bm passes through the aperture stop surface of the imaging lens 12, then enters the waveguide element 14, then is transmitted in the waveguide element 14, then exits from the light exit surface S15 of the waveguide element 14, then exits from the display window 21 in FIG. 1, and then is received by human eyes. However, the invention does not limit the position of the light exit surface of the waveguide element. For example, in other embodiments, the image beam Bm may exit from the surface S16 of the waveguide element 14. In addition, the invention does not limit the specific position of the waveguide element. In other embodiments, the relative positions of the waveguide element 14, the imaging lens 12, the image source 11 and the light source may be adjusted according to the design requirements. In addition, the imaging lens 12 in the embodiment of FIG. 6 may be replaced with the imaging lens 12a in FIG. 4.

In summary, in the head mounted display apparatus and the imaging lens of the embodiment of the invention, since the imaging lens has a light redirecting element, the image source and the lenses of the imaging lens are not necessary to be disposed in front of the wearer's eyes, as a result, the thickness of the part of the head mounted display apparatus disposed/located in front of the wearer's eyes may be made thinner.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A head mounted display apparatus, comprising:
a display device, comprising:
an image source, adapted to provide an image beam, and adjacent to a narrowing end; and
an imaging lens, disposed on a transmission path of the image beam, and disposed between an amplifying end and the narrowing end, wherein the imaging lens comprises a light redirecting element, a first lens, a second lens, and a third lens arranged sequentially from the amplifying end to the narrowing end, wherein refractive powers of the first lens, the second lens, and the third lens are positive, negative, and positive respectively.

2. The head mounted display apparatus according to claim 1, wherein the light redirecting element is a light redirecting prism, and the light redirecting element has no refractive power.

3. The head mounted display apparatus according to claim 1, wherein the light redirecting element is a light redirecting prism, and the light redirecting element has a negative refractive power.

4. The head mounted display apparatus according to claim 1, wherein the light redirecting element has a light entrance surface, a light exit surface, and a reflective surface, the light entrance surface is connected between the light exit surface and the reflective surface, the light exit surface is connected between the light entrance surface and the reflective surface, the reflective surface is connected between the light entrance surface and the light exit surface, the light entrance surface has a convex curved surface facing the first lens, the reflective surface is a flat surface, and the light exit surface has a concave curved surface.

5. The head mounted display apparatus according to claim 1, wherein the light redirecting element is a light redirecting prism and has a light entrance surface, a light exit surface, and a reflective surface, the light entrance surface is connected between the light exit surface and the reflective surface, the light exit surface is connected between the light entrance surface and the reflective surface, the reflective surface is connected between the light entrance surface and the light exit surface, the light entrance surface faces the first lens, the imaging lens has an aperture stop surface, the aperture stop surface is opposite to the light exit surface, and the imaging lens satisfies at least one of following relationships:
(1) D<5 mm, wherein D is a distance between the aperture stop surface and the light exit surface;
(2) BEF/f>0.5, wherein BEF is a back focal length of the imaging lens, and f is an effective focal length of the imaging lens;
(3) 1<TTL/f<5, wherein TTL is a total length of the imaging lens.

6. The head mounted display apparatus according to claim 1, wherein the light redirecting element is a semi-transmissive-and-semi-reflective element.

7. The head mounted display apparatus according to claim 1, wherein the imaging lens further comprises a fourth lens, the fourth lens has a negative refractive power, and the light redirecting element is disposed between the first lens and the fourth lens.

8. The head mounted display apparatus according to claim 7, wherein the fourth lens is a convex-concave lens having a convex surface facing the light redirecting element, the first lens is a bi-convex lens, the second lens is a bi-concave lens, and the third lens is an another bi-convex lens.

9. The head mounted display apparatus according to claim 7, wherein the first lens, the second lens, the third lens, and the fourth lens are aspherical lenses.

10. The head mounted display apparatus according to claim 1, wherein the first lens is a bi-convex lens, the second lens is a bi-concave lens, and the third lens is an another bi-convex lens.

11. The head mounted display apparatus according to claim 1, wherein the first lens, the second lens, and the third lens are aspherical lenses.

12. The head mounted display apparatus according to claim 1, wherein the display device further comprises a waveguide element, and the waveguide element is disposed on a transmission path of the image beam projected from the imaging lens.

13. An imaging lens, adapted for a head mounted display apparatus, and adapted to be disposed between an amplifying end and a narrowing end, and the imaging lens comprising:
a light redirecting element;
a first lens;
a second lens; and
a third lens, wherein the light redirecting element, the first lens, the second lens, and the third lens are arranged sequentially from the amplifying end to the narrowing end, and refractive powers of the first lens, the second lens, and the third lens are positive, negative, and positive respectively.

14. The imaging lens according to claim 13, wherein the light redirecting element is a light redirecting prism, and the light redirecting element has no refractive power.

15. The imaging lens according to claim 13, wherein the light redirecting element is a light redirecting prism, and the light redirecting element has a negative refractive power.

16. The imaging lens according to claim 13, wherein the light redirecting element has a light entrance surface, a light exit surface, and a reflective surface, the light entrance surface is connected between the light exit surface and the reflective surface, the light exit surface is connected between the light entrance surface and the reflective surface, the reflective surface is connected between the light entrance surface and the light exit surface, the light entrance surface has a convex curved surface facing the first lens, the reflective surface is a flat surface, and the light exit surface has a concave curved surface.

17. The imaging lens according to claim 13, wherein the light redirecting element is a light redirecting prism and has a light entrance surface, a light exit surface, and a reflective surface, the light entrance surface is connected between the light exit surface and the reflective surface, the light exit surface is connected between the light entrance surface and the reflective surface, the reflective surface is connected between the light entrance surface and the light exit surface, the light entrance surface faces the first lens, the imaging lens has an aperture stop surface, the aperture stop surface is opposite to the light exit surface, and the imaging lens satisfies at least one of following relationships:
(1) D<5 mm, wherein D is a distance between the aperture stop surface and the light exit surface;
(2) BEF/f>0.5, wherein BEF is a back focal length of the imaging lens, and f is an effective focal length of the imaging lens;
(3) 1<TTL/f<5, wherein TTL is a total length of the imaging lens.

18. The imaging lens according to claim 13, wherein the light redirecting element is a semi-transmissive-and-semi-reflective element.

19. The imaging lens according to claim 13, further comprising a fourth lens, wherein the fourth lens has a negative refractive power, and the light redirecting element is disposed between the first lens and the fourth lens.

20. The imaging lens according to claim 19, wherein the fourth lens is a convex-concave lens having a convex surface facing the light redirecting element, the first lens is a bi-convex lens, the second lens is a bi-concave lens, and the third lens is an another bi-convex lens.

21. The imaging lens according to claim 19, wherein the first lens, the second lens, the third lens, and the fourth lens are aspherical lenses.

22. The imaging lens according to claim 13, wherein the first lens is a bi-convex lens, the second lens is a bi-concave lens, and the third lens is an another bi-convex lens.

23. The imaging lens according to claim 13, wherein the first lens, the second lens, and the third lens are aspherical lenses.
